(19) United States
(12) Patent Application Publication
(10) Pub. No.: US 2009/0002909 A1
(43) Pub. Date: Jan. 1, 2009

(54) Systems and Methods for Isolating Power Surges

(75) Inventors: Ronnie Gozun, Taipei (CN); Rudolf Wegener, Grenoble (FR)

Correspondence Address: Hewlett-Packard Company;Intellectual Property Administration, P.O. Box 272400, Ft. Collins, CO, 80527-2400, US

(73) Assignee: HEWLETT-PACKARD DEVELOPMENT COMPANY, L.P., Ft. Collins, CO (US)

(21) Appl. No.: 11/782,064

(22) Filed: Jul. 24, 2007

(30) Foreign Application Priority Data
Jun. 29, 2007 (EP) EP07301183

(51) Int. Cl. H02H 9/00; H02H 3/00

(52) U.S. Cl. 361/118

(57) ABSTRACT

Systems and methods for isolating an electric powered device from power surges are provided. In this regard, a representative system, among others, includes a switch that electrically couples AC signals from an AC source to an electric powered device and a surge voltage detector that is electrically coupled to the switch. The surge voltage detector is configured to receive the AC signals and detect power surges in the AC signals. Responsive to detecting a power surge in the AC signals, the surge voltage detector is configured to open the switch, thereby isolating the power surge in the AC signals from the electric powered device.

### CROSS-REFERENCE TO RELATED APPLICATION

This application claims the benefit of copending EP application having ser. no. EP07301183, filed Jun. 29, 2007, which is entirely incorporated herein by reference.

### TECHNICAL FIELD

The present disclosure relates to alternating-current (AC) signals, and more particularly, the disclosure relates to systems and methods for isolating power surges in the AC signals from an AC source.

### BACKGROUND

Some countries, typically in third world countries, have unstable alternating-current (AC) power sources. The unstable AC power sources include power surges that can damage electric powered devices, such as, for example, computers, monitors, printers and appliances, among others. Prior solutions have been incorporated in power supplies to address the unstable AC power sources; however, this makes electric powered devices more expensive.

### SUMMARY

Systems and methods for isolating an electric powered device from power surges are provided. In this regard, a representative system, among others, includes a switch that electrically couples AC signals from an AC source to an electric powered device and a surge voltage detector that is electrically coupled to the switch. The surge voltage detector is configured to receive the AC signals and detect power surges in the AC signals. Responsive to detecting a power surge in the AC signals, the surge voltage detector is configured to open the switch, thereby isolating the power surge in the AC signals from the electric powered device.

A representative method, among others, for isolating an electric powered device from power surges in AC signals comprises: receiving AC signals from an AC source; determining whether a power surge is present in the AC signals; and responsive to determining that the power surge is present in the AC signals, isolating the power surge in the AC signals from the electric powered device.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system overview that includes a surge protector.

FIG. 2 is a high-level block diagram that illustrates an embodiment of the surge protector, such as that shown in FIG. 1.

FIG. 3 is a detailed block diagram that illustrates an embodiment of the surge protector, such as that shown in FIG. 1.

FIG. 4 is a high-level flow diagram that illustrates an embodiment of the architecture, functionality, and/or operation of the surge protector, such as that shown in FIG. 1.

FIG. 5 is a detailed flow diagram that illustrates an embodiment of the architecture, functionality, and/or operation of the surge protector, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which power surges in alternating-current (AC) signals are isolated.

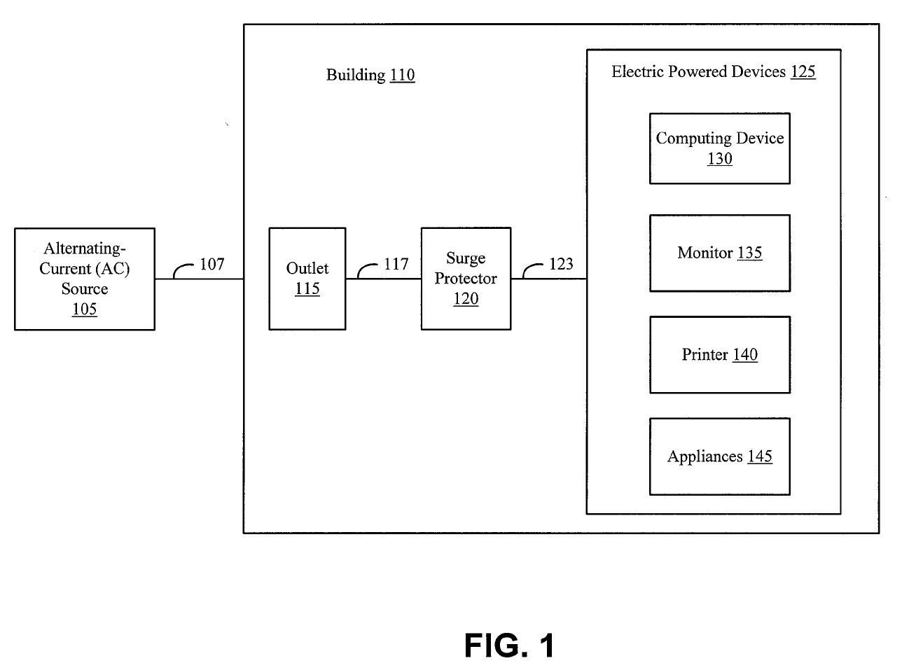

FIG. 1 is a system overview that includes a surge protector. An AC source 105 generates and transmits AC signals to a building 110 via line 107. The building 110 includes an outlet 115 that is electrically coupled to the AC source 105. A surge protector 120 can be electrically coupled to the outlet 115 via line 117. Electric powered devices 125 can be coupled to the surge protector 120 via line 123, to receive the AC signals from the AC current source 105. Generally, the surge protector includes a plug (not shown) that can be connected to the outlet 115 and at least one socket (not shown) that facilitates electrical connection to the electric powered devices 125. The electric powered devices 125 include, but are not limited to, computing devices 130, monitors 135, printers 140, and appliances 145, among others.

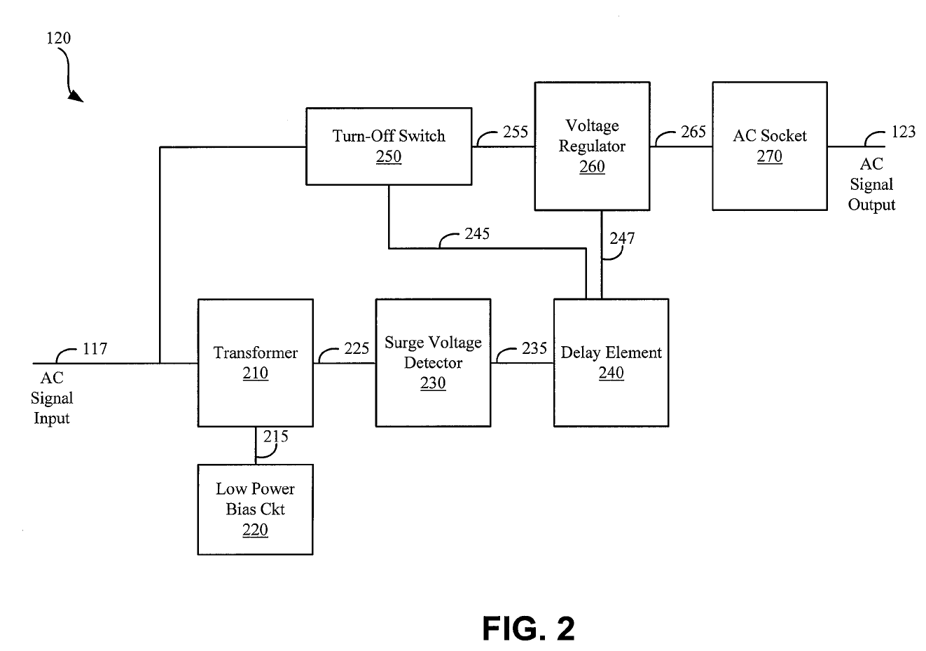

FIG. 2 is a high-level block diagram that illustrates an embodiment of the surge protector, such as that shown in FIG. 1. AC signals are received at line 117 and transmitted to a transformer 210 and a turn-off switch 250. The transformer 210 is configured to transform the voltage of the AC signals to a certain value that can be processed by the surge protector 120. The transformer 210 is further configured to isolate electronic components associated with the surge protector 120 from the actual connection to the AC source 105. The electronic components associated with the surge protector 120 include, but are not limited to, a surge voltage detector 230, a delay element 240 and a voltage regulator 260, among others.

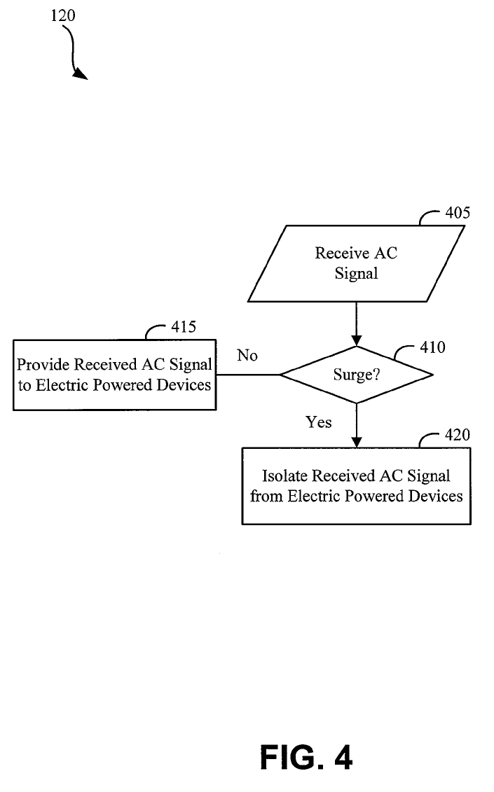

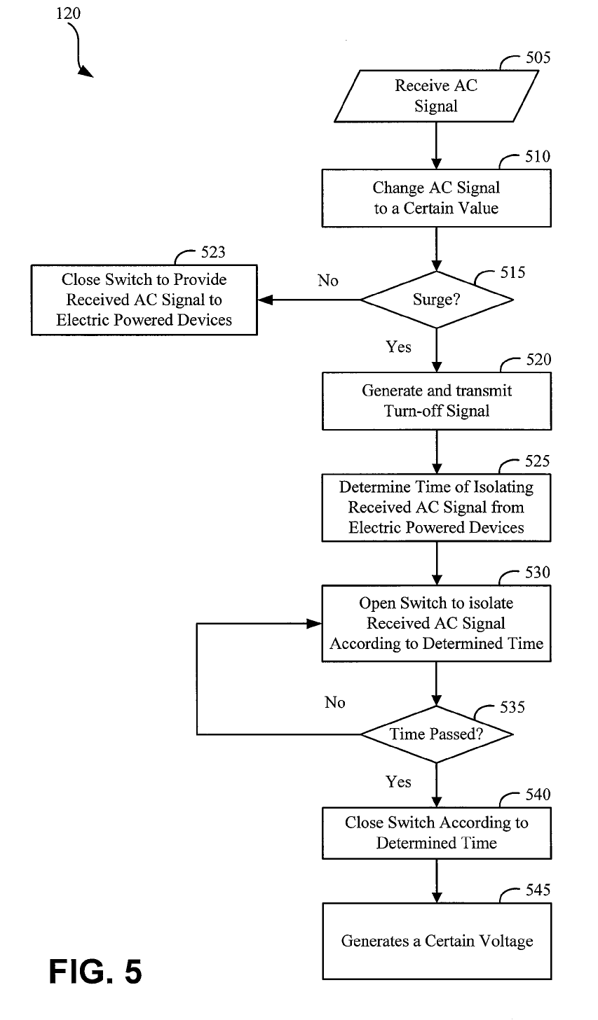

The transformer 210 provides the transformed AC signals to a low power bias circuit 220, which generates power for electrical components of the surge protector 120. The transformer 210 also provides the transformed AC signals to the surge voltage detector 230, which detects whether power surges are present in the AC signals. If the surge voltage detector 230 detects that the power surges are not present in the AC signals, the turn-off switch 250 remains close and continues to pass the received AC signals from line 117 to line 255. If the surge voltage detector 230 detects that the power surges are present in the AC signals, the surge voltage detector 230 transmits a turn-off signal to the delay element 240, which instructs the turn-off switch 250 to open disconnecting the AC signals from line 117 to line 255. The functionality of the surge voltage detector 230 is described in relation to FIGS. 4 and 5.

The delay element 240 is configured to determine a period of time the turn-off switch 250 should stay open based on the detected power surges in the AC signals. If the period of time that the turn-off switch 250 has stayed open has passed, the delay element 240 instructs the turn-off switch 250 to close thereby passing the received AC signals from line 117 to line 255. Alternatively or additionally, the delay element 240 and the turn-off switch 250 are electrically coupled to the voltage regulator 260 via lines 247, 255, respectively. The delay element 240 instructs the voltage regulator 260 to provide a certain voltage to an AC socket 270 via line 265 based on the detected power surges in the AC signals or the open or close status of the turn-off switch 250. The functionality of the delay element 240 is described in relation to FIG. 5. Alternatively or additionally, the turn-off switch 250 can be electrically coupled to the AC socket 270 without the voltage regulator 260. The AC socket 270 passes the AC signals via lines 123 to the electric powered devices 125 with little to no power surges.

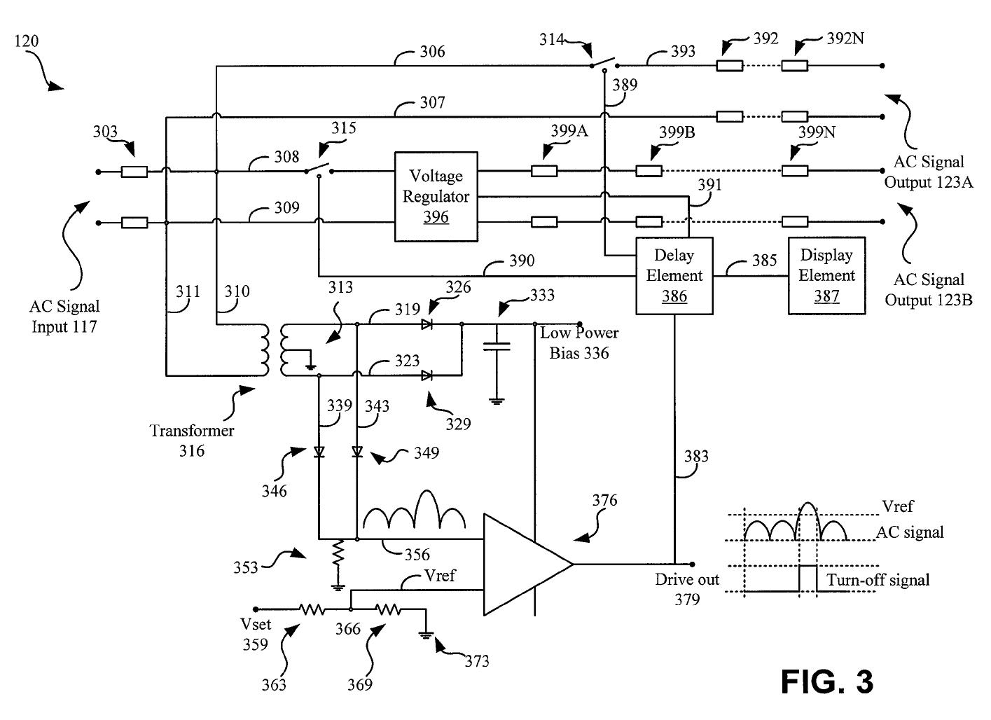

FIG. 3 is a detailed block diagram that illustrates an embodiment of the surge protector, such as that shown in FIG. 1. AC signals are received at line 117 generally by way of a plug 303 that can be electrically connected to the outlet 115 of the building 110. The AC signals are transmitted to switches 314, 315 and transformer 316 via lines 306, 307, 308, 309, 310, 311, respectively. The transformer 316 includes an adjustable tap 313 on the secondary coil of the transformer 316 that can change the received AC signals to a certain value.

The changed AC signals are transmitted to diodes 326, 329, 346, 349 via lines 319, 323, 339, 343, respectively. The diodes 326, 329 rectify the AC signals and transmit the rectified AC signals to a capacitor ground combination 333 which can generate a low power bias at node 336. The low power bias can be used as a power source by electrical components of the surge protector 120.

The rectified AC signals from the diodes 346, 349 are transmitted to a comparator 376 and a resister ground combination 353 via line 356. The comparator 376 receives a Vref signal at node 366 between resistors 363, 369. The Vref signal is determined based on the value of the Vset signal at node 359 and resistors 363, 369. The resistor 369 is electrically coupled to ground 373. The Vref value at node 366 can be adjusted by changing the values of the Vset signal at node 359 and the resistors 363, 369. The comparator 376 generates and transmits a turn-off signal via line 383 based on the AC signals surpassing the Vref value. At node 379, the turn-off signal is generated based on the magnitude of the AC signal surpassing the Vref value or a threshold value, such as that shown in an exemplary graph at node 379. The functionality of the comparator 376 is described in relation to FIGS. 4 and 5.

The turn-off signal is received by a delay element 386 via line 383. The delay element 386 transmits a command to at least one turn-off switch 314, 315 via lines 389, 390, respectively, instructing the switches 314, 315 to open thereby no AC signals are passed from the plug 303 to sockets 392, 399, respectively. Alternatively or additionally, a voltage regulator 396 is electrically coupled between the switch 315 and socket 399A. The voltage regulator 396 is configured to receive command signals from the delay element 386 via line 391 to transmit a certain voltage to the electric powered devices 125 based on the detected power surges.

Alternatively or additionally, the delay element 386 can provide a status signal to a display element 387 via line 385. The status signal includes signals for power outage, power surges, and normal AC signal, among others. The display element 387 includes, for example, a green light indicating normal AC signal activities, red light for power surges, and no light for power outage, among others. The AC signals are passed through the surge protector 120 at nodes 123A, 123B via sockets 392, 399, respectively, to the electric powered devices 125. The functionality of the delay element 386 is described in relation to FIG. 5.

FIG. 4 is a high-level flow chart that illustrates an embodiment of the architecture, functionality, and/or operation of the surge protector 120, such as that shown in FIG. 1. The surge protector 120 receives AC signals, such as that shown at step 405. Step 410 determines whether power surges are present in the received AC signals, and responsive to determining that power surges are present in the received AC signals, step 420 isolates power surges in the AC signals from the electric powered devices 125. If the power surges are not detected, step 415 passes the received AC signals to the electric powered devices 125.

FIG. 5 is a detailed flow diagram that illustrates an embodiment of the architecture, functionality, and/or operation of the surge protector 120, such as that shown in FIG. 1. The surge protector 120 receives AC signals from an AC source 105 at step 505. Step 510 changes the AC signals to a certain value. Step 515 determines whether power surges are present in the AC signals. If the power surges are not present, step 523 continues to close switches 314, 315, such as that shown in FIG. 3, to pass the received AC signals to the electric powered devices 125. If the power surges are present, step 520 generates and transmits turn-off signals to open the switches 314, 315 thereby isolating the power surges in the AC signals from the electric powered devices.

Step 525 determines a period of time that the switches 314, 315 should stay open to isolate the received AC signals from the electric powered devices. Step 530 continues to open the switches 314, 315 according to the determined period of time. Step 535 determines whether the period of time has passed in relation to closing the switches 314, 315 based on the detected power surges. If the determined period of time has not passed, step 530 continues to open the switches 314, 315. If the determined period of time has passed, step 540 closes the switches 314, 315, which, in turn, passes the received AC signals without the power surges to the electric powered devices 125. Alternatively or additionally, the determined period of time in relation to closing the switches 314, 315 can be longer than the occurrence of the power surges.

Alternatively or additionally, step 545 generates and passes a certain voltage to the electric powered devices based on the detected power surges rather than providing no voltage to the electric powered devices as implied at step 530. Alternatively or additionally, step 545 can regulate voltage based on the open and close state of the switch. Alternatively or additionally, step 545 can regulate voltage to the electric powered devices 125 according to the determined period of time.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as is suited to the particular use contemplated. All such modifications and variation are within the scope of this disclosure, as determined by the appended claims when interpreted in accordance with the breadth to which they are fairly and legally entitled.

What is claimed:

1. A surge protector comprising:
a switch that electrically couples alternating-current (AC) signals from an AC source to at least one socket that can be electrically coupled to at least one electric powered device; and
a surge voltage detector that is electrically coupled to the switch, the surge voltage detector being configured to receive the AC signals and detect power surges in the AC signals, responsive to detecting the power surges in the AC signals, the surge voltage detector being configured to transmit turn-off signals to the switch instructing the switch to open, thereby isolating the power surges in the AC signals from the at least one electric powered device.

2. The surge detector as defined in claim 1, further comprising a transformer that receives the AC signals and transforms the AC signals to a certain value, the transformer being configured to transmit the transformed AC signals to the surge voltage detector.

3. The surge protector as defined in claim 2, further comprising a low power bias circuitry that receives the transformed AC signals from the transformer and provides power to electrical components of the surge protector.

4. The surge protector as defined in claim 1, further comprising a delay element that is configured to receive the turn-off signals from the surge voltage detector, the delay element being further configured to transmit the turn-off signals to the switch instructing the switch to open, thereby isolating the at least one electric powered device from the power surges in the AC signals, the delay element being further configured to determine a period of time that the switch should stay open based on the detected power surges, responsive to determining that the period of time that the switch stayed open has passed, the delay element being further configured to instruct the switch to close, thereby passing the AC signals without the power surges to the at least one electric powered device.

5. The surge protector as defined in claim 4, further comprising a voltage regulator being electrically coupled between the switch and the at least one socket, the voltage regulator being configured to receive command signals from the delay element to transmit a certain voltage to the at least one electric powered device via the at least one socket based on the detected power surges.

6. The surge protector as defined in claim 1, further comprising at least one plug that is electrically coupled to the switch.

7. The method for isolating at least one electric powered device from power surges in AC signals, the method comprising:
receiving alternating-current (AC) signals from an AC source;
determining whether a power surge is present in the AC signals; and
responsive to determining that the power surge is present in the AC signals, isolating the power surge in the AC signals from the at least one electric powered device.

8. The method as defined in claim 7, further comprising changing the AC signals to a certain value.

9. The method as defined in claim 7, further comprising responsive to determining that the power surge is not present in the AC signals, passing the received AC signals to the at least one electric powered device.

10. The method as defined in claim 7, further comprising generating and transmitting turn-off signals to a switch instructing the switch to open thereby isolating the power surge in the AC signals from the at least one electric powered device responsive to determining that the power surge is present in the AC signals.

11. The method as defined in claim 7, further comprising determining a period of time that the switch should stay open based on the determined power surge.

12. The method as defined in claim 11, further comprising isolating the power surge in the AC signals from the at least one electric powered device according to the determined period of time or based on the close and open status of the switch.

13. The method as defined in claim 12, further comprising responsive to determining that the period of time that the switch stayed open has passed, passing the received AC signals without the power surge to the at least one electric powered device.

14. The method as defined in claim 11, further comprising transmitting a certain voltage to the at least one electric powered device based on the determined power surge.

15. A system for isolating at least one electric powered device from power surges in AC signals, the system comprising:
at least one electric powered device that receives alternating-current (AC) signals from an AC source; and
a surge protector that is electrically coupled between the at least one electric powered device and the AC source, the surge protector comprising,
a switch that electrically couples the AC signals from the AC source to the at least one electric powered device, and
a surge voltage detector that is electrically coupled to the switch, the surge voltage detector being configured to receive the AC signals and detect power surges in the AC signals, responsive to detecting a power surge in the AC signals, the surge voltage detector being configured to transmit turn-off signals to the switch instructing the switch to open thereby isolating the power surge in the AC signals from the at least one electric powered device.

16. The system as defined in claim 15, wherein the surge protector further comprises a transformer that receives the AC signals and transforms the AC signals to a certain value, the transformer being configured to transmit the transformed AC signals to the surge voltage detector.

17. The system as defined in claim 16, wherein the surge protector further comprises a low power bias circuitry that receives the transformed AC signals from the transformer and provides power to electrical components of the surge protector.

18. The system as defined in claim 15, wherein the surge protector further comprises a delay element that is configured to receive the turn-off signals from the surge voltage detector, the delay element being further configured to transmit the turn-off signals to the switch instructing the switch to open, thereby isolating the at least one electric powered device from the power surge present in the AC signals, the delay element being further configured to determine a period of time that the switch should stay open based on the detected power surge, responsive to determining that the period of time that the switch stayed open has passed, the delay element being further configured to instruct the switch to close thereby passing the AC signals without the power surges to the at least one electric powered device.

19. The system as defined in claim 18, wherein the surge protector further includes a voltage regulator being electrically coupled between the switch and the at least one electric powered device, the voltage regulator being configured to receive command signals from the delay element instructing the voltage regulator to transmit a certain voltage to the at least one electric powered device responsive to determining that the power surge is present in the AC signals.

20. The system as defined in claim 18, wherein the surge protector further includes a display element that is electrically coupled to the delay element, the display element being configured to indicate the activity status of the surge protector.
